(19) United States
(12) Patent Application Publication
(10) Pub. No.: US 2007/0274486 A1
(43) Pub. Date: Nov. 29, 2007

(54) Call-Control Features Based on Television Programming Events

(75) Inventor: Thomas F. Kister, Chalfont, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/743,953

(22) Filed: May 3, 2007

Related U.S. Application Data
(60) Provisional application No. 60/797,297, filed on May 3, 2006.

(51) Int. Cl. H04M 15/06; H04M 1/56

(52) U.S. Cl. 379/142.06

(57) ABSTRACT

Described herein are systems and methods for providing call-control features based on information about the programming events. The call-control features are provided to control, handle, or otherwise manage incoming telephone calls. The programming events may be television programming events such as broadcast, pay-per-view, or video-on-demand shows, movies, or the like. A computerized set top box (STB) may be used to output the programming events for display on a television or any other suitable display device. The STB is operable to receive notices of incoming telephone calls and manage such calls with call-control features that are associated with the programming events output by the STB based on information, such as content or metadata about, such programming events.

### PRIORITY

This application claims the benefit of the prior-filed U.S. Provisional Patent Application No. 60/797,297, filed on May 3, 2006, and entitled, “CALL-CONTROL FEATURE BEHAVIOR BASED ON TV EVENT AND USER PREFERENCE,” which is herein incorporated by reference in its entirety.

### BACKGROUND

Traditionally, digital set top boxes (STBs) have been widely available for providing viewers with television programming services, such as cable and satellite television services. Recent advent of voice-over-internet-protocol (VoIP) telephony services, internet-protocol television (IPTV) services, and the push for convergence of digital technologies also have given rise to new STBs that are capable of providing consumers with both video programming and telephone services. For example, some existing STBs can provide users with both telephony and television services and the ability to display caller identification (CID) during television viewing.

### BRIEF DESCRIPTION OF THE DRAWINGS

Embodiments are illustrated by way of example and not limited in the following figure(s), in which like numerals indicate like elements, in which:

FIG. 1A illustrates an example of a system for providing television programming and telephone services to set top boxes (STBs) at remote user locations;

FIG. 1B illustrates an example of a STB that may be used in the system illustrated in FIG. 1A;

FIG. 2 illustrates another example of a system for providing television programming and telephone services to set top boxes (STBs) at remote user locations;

FIG. 3 illustrates a method for setting up call-control features based on programming events and user preferences; and

FIG. 4 illustrates a method for providing call-control features once they are set up to manage incoming telephone calls or call notifications thereof.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description.

STBs make available television programming (including audio, video, and/or multimedia) events that may be significant to viewers, such as a season premiere television show, a new-show premiere, a major sports event like the Super Bowl or the World Series, a pay-per-view (PPV) movie, or a video on demand (VOD) programming. With additional capabilities of the aforementioned integrated STBs, there are numerous possibilities whereby a STB-provided viewer's program may be disrupted by incoming calls, caller identification (CID) displays, and other messages. Thus, the viewer has to remember to disable such messaging features for all channels and times before the desired program is displayed to avoid viewing disruption of such a program.

Accordingly, described herein are systems and methods for providing users of STBs with automated call-control features based on television programming events or content thereof and user preferences. According to various embodiments described herein, a viewer may manage incoming calls by having call control, CID, and other messaging features on the STB automatically enabled or disabled based on a television programming event, one or more user preferences, or both, as opposed to having to manually enable or disable such features.

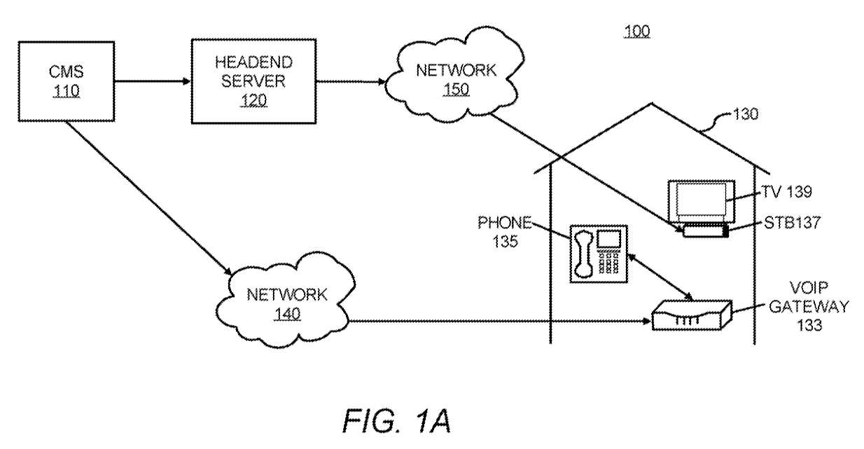

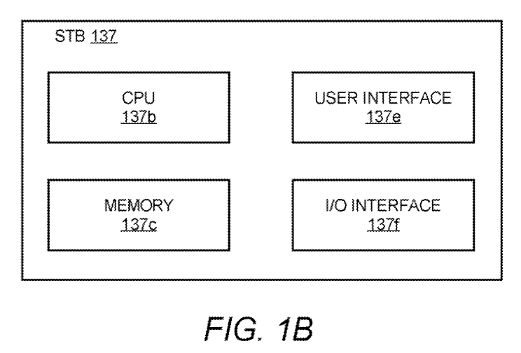

FIG. 1A illustrates an example of a system 100 for providing television programming and telephone services to STBs at remote user locations. The system 100 includes a call management server (CMS) 110 hosted by a telephone service provider (e.g., a VoIP telephone service provider or a plain old telephone service, or POTS, provider), a headend server 120 hosted by a television programming service provider (e.g., a cable television service provider or a satellite service provider), and one or more STBs 137 located at a user location 130 (e.g., home, residence, lodging unit, or any other customer's premise).

The CMS 110 is operable to provide telephone service to the user location 130 via a network 140. In the scenario wherein the provided telephone service is a POTS, the network 140 may be the conventional public switched telephone network (PSTN). In the second scenario wherein the provided telephone service is a VoIP service, the network 140 may be an IP network, such as the public Internet or a private dedicated IP network provided by the telephone service provider. In the second scenario, the user location 130 further includes a VoIP gateway device 133 to which a telephone 135 may be connected to receive the VoIP service. The VoIP gateway device 133 may be an embedded multimedia terminal adapter (E-MTA) or may include a separate standalone multimedia terminal adapter (S-MTA) that is in communication with the network 140 via a modem to enable the telephone 135 connected thereto to receive the VoIP service.

The headend server 120 is operable to capture the user's subscription to the television programming service and provide the same to the user location 130 via a network 150, such as a hybrid fiber-coaxial (HFC) network for a cable television service, an IP network like the Internet for an IPTV service, or a terrestrial network for a satellite television service. The headend server 120 is also operable to capture the user's subscription to the telephone service by registering each STB 137 at the user location 130 and correlating such STB(s) with one or more phone numbers used by the telephone 135 at the user location 130. To that effect, the headend server 120 may include therein a CID server to receive from the CMS 110 CID notifications for telephone calls incoming to the user location 130.

FIG. 1B illustrates an STB 137 that may be used in the system 100 illustrated in FIG. 1A. Each STB 137 is shown as a receiver having, among other components, a central processing unit (CPU) 137b, a memory 137c, a user interface 137e, and an I/O interface 137f. A communication bus (not shown) may be implemented to provide connection between the aforementioned components and other components in the STB 137 in a known manner. The STB 137 may be implemented using any known hardware and software (including firmware).

The memory 137c may be implemented as a computer readable medium (CRM) having stored thereon software applications, programs, or modules. These software applications include computer executable instructions that provide any number of functions and operations of the STB 137. The computer-executable program instructions include code from any suitable computer-programming language, such as C, C++, C#, Java, or the like. Examples of a CRM include but are not limited to an electronic, optical, magnetic, or other storage or transmission device capable of providing a processor, such as the CPU 137b, with computer-readable instructions. Other examples of a suitable CRM include, but are not limited to, a floppy disk, CD-ROM, DVD, magnetic disk, memory chip, ROM, RAM, an ASIC, a configured processor, any optical medium, any magnetic tape or any other magnetic medium, or any other medium from which a computer processor is operable to read instructions.

In one example, the software applications stored in the memory 137c enable the STB 137 to receive, store, and display an electronic program guide (EPG) from the television service provider. The EPG may be stored in a database that also resides in the memory 137c or any other suitable storage space in the STB 137. As referred herein, an EPG provides information or metadata about the television programming events or content thereof that are available for viewing via the STB 137 by the user at the user location 130. The available television programming events or content include programming events or content provided by television broadcasting networks, pay-per-view (PPV) programming events or content, and video-on-demand (VOD) programming events or content, Thus, information or metadata of a programming event may include a text summary of the programming event, classification of the programming event, the channel and time for the programming event, and any other information that describes or identifies the programming event. The software applications also enable the STB 137 to receive and display content of programming events (e.g., network television broadcasts, PPVs, VODs) on one or more television channels and CID information of incoming telephone calls to the user location 130 (FIG. 1A). The software applications in the memory 137c also provide call-control features that allow a user to control, handle, or manage incoming telephone calls as provided by the telephone service provider. The call-control features may make use of the EPG to enable the user to control incoming telephone calls and call notifications thereof based on television programming events or content thereof as identified from the EPG and user preferences. As referred herein, a call notification includes an audio or visual notification of an incoming telephone call to a designated location. Examples of a call notification includes an audio chime or a visual display of the CID information of an incoming telephone call to the user location 130 (FIG. 1A).

In a first scenario, the user may call up the EPG and specify or program one or more favorite programming events therein, such as the Super Bowl, the World Series, or any VOD programming event, wherein during the showing of such events, the STB 137 prevents or blocks a passing of call notifications such as the CID information of incoming telephone calls for display, e.g., on the television 139, so as not to disrupt the user's viewing of the specified events. Other user-desired programming events may be searched from the EPG by the user and include season-premiere or season-finale shows or programming events that contain user-specified actors, actresses, or other keywords. Accordingly, when the user watches a previously-specified favorite programming event, the user will not be disrupted by the display of CID information on the television 139. Alternatively, when the user first tunes to a previously-specified programming event, the user is initially prompted with an inquiry as to whether the user wishes to disable the CID display.

In a second scenario of call-control features, the user initially may go through the event programming of the first scenario to set up the desired call-control features. However, the user may further specify one or more exceptions to the features so as to allow the STB 137 to pass through certain incoming calls for display on, e.g., the television 139, regardless of the currently-viewed events or content thereof. For example, the user may be a parent who wishes to always be notified of telephone calls from his or her children. Thus, the user may allow only the CID information of the children's cell phone numbers to be displayed when the children call with their cell phones while blocking other incoming call numbers during a desired programming event.

In a third scenario of call-control features, instead of specifying a particular television programming event for call control, the user may specify other metadata of the programming event, such as a television channel with or without a desired time period for application of the call control. For example, the user may specify that when the STB is on and tuned to Channel 5, regardless of the time, no CID information of incoming calls should be displayed. In another example, the user may specify that when the STB is on and tuned to Channel 5 between 6 PM-6:30 PM for a news programming event, no CID information of incoming calls should be displayed, while at other times the CID information of incoming calls is passed through by the STB 137 for display on the television 139.

The aforementioned scenarios are but a few of many possible scenarios that are available to the user to specify call controls based on television programming events and user preferences for such events. For example, the three scenarios may be combined in whole or in part to create other scenarios. Also, because call controls are based on television programming events instead of just time based, anytime the user decides to “channel surf” to a different channel having a different programming event (e.g., during a commercial break), any call controls are disabled and CID information of incoming calls may be displayed because the user is no longer viewing a user-specified event.

It should be understood that the call-control features allow the user to specify call controls for live viewing of the specified events (i.e., viewing of a specified event as it is being broadcasted or transmitted by the television service provider), viewing of previously-recorded events as saved on the STB 137 (i.e., viewing of a specified event as previously recorded on the STB 137 via an available event recording function such as a digital or personal video recorder of the STB 137), or both. Thus, it does not matter when the user-specified events are shown, as long as they are shown or played by the STB 137, the user-specified call-control features associated with such user-specified events are applied.

The aforementioned scenarios for call-control features have been discussed with reference to the enabling, disabling, and scheduling of the display of CID information. However, it should be understood that other call-control features may be applied by the user as well. Examples of other call-control features include but are not limited to: automatic forwarding of all incoming calls to voicemail or to another phone number (via messaging from the STB 137 back to the headend server 120 which then handles the call interaction with the CMS 110), and enabling/disabling of voicemail notifications, muting/volume increase of the currently-viewed programming event for additional attention or disregard to incoming calls, and automatic stopping or pausing of the currently-viewed programming event for additional attention to incoming calls. Table 1 provides some examples of possible user inputs of desired programming events and call-control features associated with such events.

TABLE 1

| User-Desired | |
|---|---|
| Programming Events | User-Desired Call-Control Functions |
| Super Bowl, PPV, and | Block CID information of all incoming calls. |
| VOD events | |
| King of Queens, series | Block CID information of all incoming calls |
| finale | except from kids. |
| Channel 5, from | Forward calls to voicemail. |
| 7 PM–8 PM on weekdays | |
| Channel 7 (all times) | Muting of currently-viewed programming |
| | event upon receipt of call notifications of |
| | incoming calls. |

In another example, the software applications in the memory 137c may further enable the STB 137 to access user private data (e.g. credit card numbers, personal preferences, etc.), purchase or order programming events, provide parental lockout capability for one or more television channels, dialing a modem for on-line shopping, interactive network communication, and the like. A common characteristic of the aforementioned STB functions and operations is that it is desirable to protect these functions from unauthorized access through implementation of a security function, which receives and processes security policy data from the headend server 120 to enable the receiver function 137a in any known manner. Thus, the software applications in the memory 137c may implement such a security function (possibly in conjunction with additional hardware not shown) for the STB 137 as well.

The CPU 137b in the STB 137 includes one or more processors of any of a number of computer processors, such as processors from Intel, AMD, or Cyrix. Each processor is coupled to or includes at least one memory device, such as a computer readable medium (CRM). The processor is operable to execute computer-executable program instructions in software applications stored in a CRM, such as the aforementioned software applications stored in the memory 137c of the STB 137.

The user interface 137e allows a user to enter commands or modify parameters for any of the aforementioned functions or operations that are available to the STB 137 using a conventional interface device, such as a hand held remote control. An appropriate graphical user interface (GUI) may be provided on a display, such as a television 139, via a display adapter (not shown) for this purpose.

The Input/Output (I/O) interface 137f enables the STB 137 to communicate with the headend server 120 in a known manner, depending on the type of the network 150. For example, if the network 150 is a HFC network, the I/O interface 137f may include modem capabilities for modulating and demodulating signals. In another example, a modem (not shown) may be separately provided, in which case, the I/O interface 137f allows the STB 137 to communication with such a modem to send and receive signals.

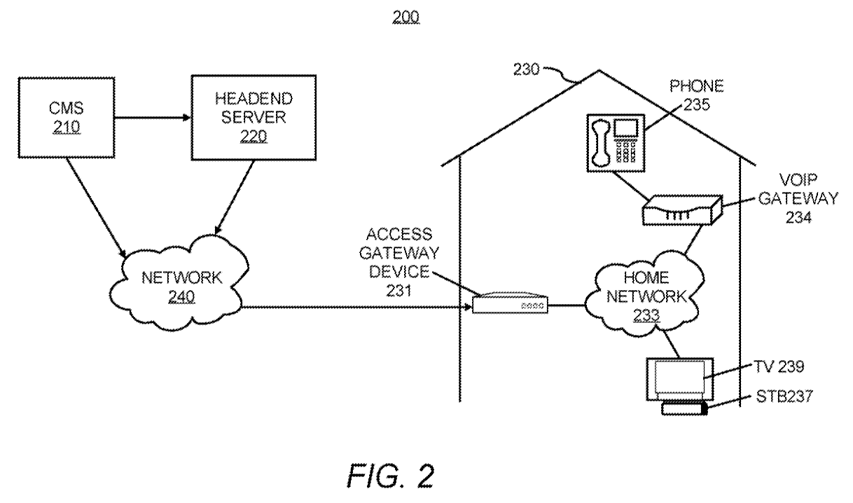

FIG. 2 illustrates another example of a system 200 for providing television programming and telephone services to STBs at remote user locations. Similar to the system 100, the system 200 includes a CMS 210, a headend server 220, and one or more STBs 237 located at a user location 230. Similar to the CMS 110 (FIG. 1A), the CMS 210 is hosted by a telephone service provider, e.g., a VoIP telephone service provider that is capable of providing telephone service via the network 240, which may be an IP network. The headend server 220 operates as described above for the headend server 120 (FIG. 1A). In the system 200, the user location 230 includes an access gateway device 231 that acts as a gateway for providing both television programming and telephone services to the user location 230 via a home network 233, such as a private IP network. Thus, the STB 237 is operable to receive television programming events via the home network 233 for display on the television 239. The STB 237 is identical to the STB 137, except that its I/O interface (137f) is operable to send and receive signals via the home network 233 instead of an external network (150). The telephone 235 may be connected to a VoIP gateway device 234, which operates like the VoIP gateway device 133 (FIG. 1A), to receive a telephone service via the same home network 233. In the system 200, the VoIP gateway device 234 is further operable to discover the STB 237 by, for example, universal plug and play (UPnP) so as to forward CID information via UPnP event notifications to the STB 237. In return, the STB 237 may provide UPnP announcements to the VoIP gateway 234 to control features of the telephone service.

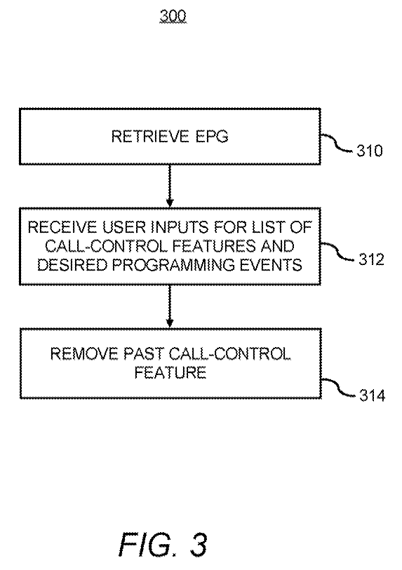

FIG. 3 illustrates a process or method 300 for setting up automated call-control features based on television programming events or content thereof and user preferences. For illustrative purposes only and not to be limiting thereof, the method 300 is discussed in the context of the system 100. For example, the method 300 may be implemented by software applications in the memory 137c as executed by the CPU 137b. However, it should be understood that the method 300 is also applicable for the system 200, and corresponding components therein, or any other suitable system.

At 310, the STB 137 retrieves, receives, or obtains an EPG from the headend server 120 as provided by a television service provider and stores the EPG in the memory 137c or any other desired storage space in the STB 137. On a periodic basis, the retrieval and storage of the EPG may be automatically executed or prompted by the user. For example, the STB 137 may be scheduled to receive an updated EPG on a weekly, daily, or hourly basis.

At 312, the STB 137 provides the user with an option to set up call-control features based on the content of the user-specified television programming events and user preferences, and the STB 137 receives such user inputs. As referred herein, a call-control set-up includes an activation of the call-control features as well; however, they may be separate functions, and the call-control features function once they are activated. The call-control set-up may be prompted automatically at start-up of the STB 137, automatically at predetermined time intervals (e.g., every day), or by the user through an available graphical user interface (GUI) as provided by the user interface 137e.

Accordingly, the call-control set-up allows the user to input, via the GUI, the desired call-control features, the desired television programming events that trigger the associated call-control features as described in various scenarios above, and the activation of such call-control features. For example, the GUI may provide a listing of available call-control features from which the user can choose (one or more) for one or more desired programming events. Examples of call-control features include: enabling/disabling of a display of CID information for incoming calls, enabling/disabling of forwarding incoming calls to voicemail, enabling/disabling a display of voicemail notification, an initial prompt to implement any one or more of the aforementioned features, and exceptions to any of the aforementioned features. The user is also allowed to search the EPG, via the GUI provided by the user interface 137e, for the desired television programming events that can trigger the user-specified call-control features. For example, the user may search the EPG for the Super Bowl, whereby the call-control feature for disabling the display of CID information is applied.

At 314, The user-desired or specified programming events are added to a list along with the desired call-control features for each of the programming event and stored in the STB 137, e.g., in a database residing in the memory 137c.

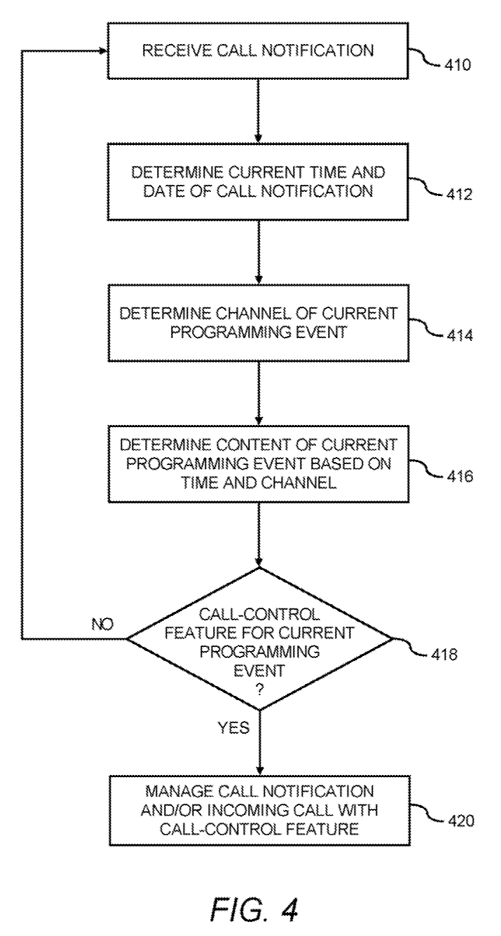

Accordingly, once the call-control features are set up by the user with the method 300, call notifications of incoming telephone calls will be subjected to such features, as illustrated in FIG. 4. Again, for illustrative purposes only and not to be limiting thereof, the method 400 is discussed in the context of the system 100 (FIG. 1A). For example, the method 400 may be implemented by one or more software applications residing in the memory 137c and executed by the CPU 137b.

At 410, a call notification of an incoming telephone call is received at the STB 137. For example, an incoming call is received at the phone 135 and its CID information is received at the STB 137 at the user location 130.

At 412, the STB 137 determines the current time and date as the call notification is received. For example, the STB 137 may include an internal clock that places a time stamp on the call notification.

At 414, the STB 137 determines the channel of the currently-viewed programming event as the call notification is received. The currently-viewed channel may be, for example, a network television channel (e.g., ABC, CBS, NBC, FOX) a cable television network channel (e.g., ESPN, USA, Sci-Fi), or a channel dedicated for PPV or VOD programming events.

At 416, the STB 137 determines the content of the programming event that the STB 137 currently outputs for display. This determination may be achieved by using the time, date, and channel information obtained at 412 and 414, to query the stored EPG to retrieve information about the current programming event. For example, the STB 137 receives a call notification at 7:25 PM on a Super Bowl Sunday as the user was watching Channel 5. The STB 137 then looks up the EPG to determine that the programming event that was scheduled to play or broadcast on Channel 5 at 7:25 PM on Sunday is indeed the Super Bowl.

At 418, the STB 137 checks to see if there is any call-control feature set up for the current programming event from the user-specified list of programming events and associated call-control features. For example, as shown in Table 1, the user-specified list indicates that for the Super Bowl, the CID display is to be disabled for incoming calls. Since the Super Bowl is in the user-specified list, the CID information of the incoming call is not displayed on the television 139.

At 420, if there is a call-control feature set up for the current programming event, the STB 137 implements the call-control feature to manage the incoming call; otherwise, no call-control feature is implemented, and the process 400 returns to 410 to receive the next incoming call.

It should be understood that at any time the user may modify the call-control features, the user-specified programming events, or both at 312 in the method 300, which then affects the implementation of the method 400.

Although the present disclosure has been discussed with reference to a STB and electronic programming events, it should be understood that such a discussion is applicable for any receiver that is operable to receive television or other multimedia programming events and enable a display of such events on a viewing device. Thus, for example, a television may have a built-in receiver with the aforementioned STB features.

In recap, the systems and methods as provided herein enable automated implementation of call-control features based on television programming events and user preferences that further enhance the user's experience with both the telephone and television services.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for providing a call-control feature in a receiver, comprising:
receiving a call notification of an incoming telephone call at a receiver;
determining a content of a programming event that the receiver currently outputs for display as the call notification is received; and
implementing a call-control feature to manage the call notification at the receiver based on the determined content of the programming event.

2. The method of claim 1, further comprising:
implementing the call-control feature to further manage the incoming telephone call based on the determined content of the programming event.

3. The method of claim 1, wherein the step of determining the content of the programming event comprises:
retrieving information about the programming event from an electronic program guide maintained by the receiver.

4. The method of claim 3, further comprising:
determining a channel of the programming event.

5. The method of claim 4, further comprising:
determining a time that the call notification is received.

6. The method of claim 4, wherein the step of retrieving information about the programming event from the EPG includes:
retrieving information about the programming event from the EPG based on the determined channel of the programming event.

7. The method of claim 5, wherein the step of retrieving information about the programming event from the EPG includes:
retrieving information about the programming event from the EPG based on the determined channel of the programming event and the time of the call notification.

8. The method of claim 1, wherein the receiver is a television set top box, and the programming event is a television programming event.

9. The method of claim 1, wherein:
the call notification includes a caller identification (ID) identifying a telephone number that originates the incoming telephone call; and
the call control feature includes a blocking of display of the caller ID.

10. A method for providing call control of an incoming telephone call during a televised programming event that is currently output for display, comprising:
receiving a call notification of the incoming telephone call;
determining a content of the televised programming event in response to the received call notification; and
implementing a call-control feature to manage the incoming telephone call based on the determined content of the programming event.

11. The method of claim 10, further comprising:
implementing the call-control feature to further manage the call notification of the incoming telephone call based on the determined content of the programming event.

12. The method of claim 10, wherein:
the call notification includes a caller identification (ID) identifying a telephone number that originates the incoming telephone call; and
the call control feature includes a blocking of display of the caller ID.

13. The method of claim 10, further comprising:
determining a channel of the programming event; and
determining a time that the call notification is received.

14. The method of claim 13, wherein the step of retrieving information about the programming event from the EPG includes:
retrieving information about the programming event from the EPG based on the determined channel of the programming event and the time of the call notification.

15. A computerized receiver having a computer readable medium therein, and encoded on the computer readable medium is computer-executable programming code executed by the computerized receiver to:
receive a call notification of an incoming telephone call at a receiver;
determine a content of a programming event that the receiver currently outputs for display in response to the received call notification; and
implement a call-control feature to manage the call notification and the incoming telephone call at the receiver based on the determined content of the programming event.
